(19) United States
(12) Patent Application Publication
(10) Pub. No.: US 2018/0276642 A1
(43) Pub. Date: Sep. 27, 2018

(54) POINT-OF-SALE TERMINAL CONFIGURED GENERATE A RECEIPT WITH A SECURITY WATERMARK

(71) Applicant: TOSHIBA TEC KABUSHIKI KAISHA, Tokyo (JP)

(72) Inventor: Koichi SUGIYAMA, Izunokuni Shizuoka (JP)

(21) Appl. No.: 15/885,191

(22) Filed: Jan. 31, 2018

Related U.S. Application Data
(63) Continuation of application No. 14/600,834, filed on Jan. 20, 2015, now abandoned.

(30) Foreign Application Priority Data
Jan. 21, 2014 (JP) 2014-008927
Sep. 22, 2014 (JP) 2014-192796

(51) Int. Cl. G06Q 20/20

(52) U.S. Cl. CPC G06Q 20/209; G06K 19/06037; G06Q 20/202; G06Q 20/208

(57) ABSTRACT

A point-of-sale (POS) terminal is configured to generate a security watermark for receipts to protect against counterfeit receipts. The POS terminal includes a code reader, a printer, and a processor configured to register items to be purchased by a user based on codes read by the code reader and associate the registered items with a user code if one of the codes read by the code reader is the user code. Upon completion of a purchase transaction for the registered items, the processor causes the printer to print a paper receipt without a security watermark if none of the codes read by the code reader is the user code and generates an electronic receipt with a security watermark if one of the codes read by the code reader is the user code.

### FIELD

Embodiments described herein relate generally to a point-of-sale terminal configured to generate a receipt with a security watermark.

### BACKGROUND

In the related art, data about a purchase transaction are printed on a paper receipt and a customer receives the receipt to confirm the purchase transaction. Recently, the data have been provided through an electronic receipt. An electronic device of a customer receives the data of the electronic receipt and displays the contents so that the customer can review them.

The electronic receipt is beneficial to a customer who wants to record and track the history of purchase transactions, because the electronic receipt makes recordkeeping easier. Further, the electronic receipt is beneficial to a store that wants to reduce the printing cost for paper receipts.

### DESCRIPTION OF THE DRAWINGS

FIG. 1 illustrates overall configuration of an electronic receipt system according to an embodiment.

FIG. 2 is a block diagram of a POS terminal in the electronic receipt system according to an embodiment.

FIG. 3 is a memory map of a data storage unit of the POS terminal.

FIG. 4 is a block diagram of an electronic receipt management server in the electronic receipt system according to an embodiment.

FIG. 5 is a memory map of a data storage unit of the electronic receipt management server.

FIG. 6 is a block diagram of a mobile terminal in the electronic receipt system according to an embodiment.

FIG. 7 is a flowchart of control processing carried out by the POS terminal.

FIG. 8 is a flowchart of merchandise return processing carried out by the POS terminal.

FIG. 9 is a flowchart of register-minus processing carried out by the POS terminal.

FIG. 10 is a functional block diagram of the electronic receipt management server.

FIG. 11 is a flowchart of control processing carried out by the electronic receipt management server.

FIG. 12 is a flowchart of merchandise return processing carried out by the electronic receipt management server.

FIG. 13 is a flowchart of register-minus processing carried out by the electronic receipt management server.

FIG. 14 is an example of an electronic receipt displayed on the mobile terminal.

FIG. 15 is another example of the electronic receipt displayed on the mobile terminal.

### DETAILED DESCRIPTION

Embodiments provide a point-of-sale terminal configured to generate a receipt with a security watermark.

In general, according to one embodiment, a point-of-sale (POS) terminal is configured to generate a security watermark for receipts to protect against counterfeit receipts. The POS terminal includes a code reader, a printer, and a processor configured to register items to be purchased by a user based on codes read by the code reader and associate the registered items with a user code if one of the codes read by the code reader is the user code. Upon completion of a purchase transaction for the registered items, the processor causes the printer to print a paper receipt without a security watermark if none of the codes read by the code reader is the user code and generates an electronic receipt with a security watermark if one of the codes read by the code reader is the user code.

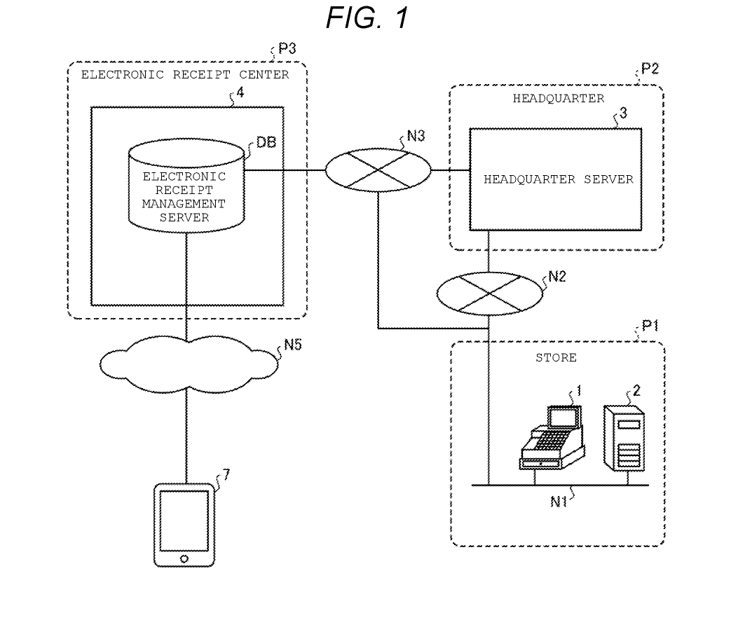

Hereinafter, an embodiment will be described with referring to FIGS. 1 to 15. In the embodiment, an electronic receipt management server will be described as an example of an information processing apparatus. A mobile terminal will be described as an example of a reception destination device. It should be noted that the description according to the embodiment is not intended to limit the disclosure.

FIG. 1 illustrates the overall configuration of an electronic receipt system according to an embodiment. As illustrated in FIG. 1, the electronic receipt system includes a point of sales (POS) terminal 1, a store server 2, an electronic receipt management server 4, and a mobile terminal 7. Furthermore, the electronic receipt system includes a headquarter server 3 as a host server of the POS terminal 1 or the store server 2. It should be noted that the headquarter server 3 may or may not be included in an electronic receipt system.

The POS terminal 1 and the store server 2 are provided in a store P1. The POS terminal 1 and the store server 2 are communicably connected through a network N1, such as a local area network (LAN), in the store P1. The POS terminal 1 and the store server 2 are connectable to a network N2 connecting the store P1 and the headquarter server 3 provided in a headquarter P2, through a network device (not illustrated), such as a router, connected to the network N1 in the store P1. The network N2 is, for example, the Internet or a dedicated line, such as a virtual private network (VPN).

The POS terminal 1 is a merchandise sales data processing apparatus which performs merchandise sales data processing on merchandise sales information of checkout processing of items for. The POS terminal 1 generates receipt data including the transaction contents about items to be checked out based on the merchandise sales information for each transaction and prints paper receipts using a printing unit 13 described below. The POS terminal 1 outputs (transmits) electronic receipt data, which is converted into a data format of receipt data, directly to the electronic receipt management server 4 through a network N3 without passing through the headquarter server 3. A transmission method of electronic receipt data is not particularly limited, and a general-purpose protocol, such as HTTP or HTTPS, may be used.

The store server 2 performs general management of processing, such as the merchandise sales data processing carried out by the POS terminal 1. For example, the store server 2 stores and manages merchandise sales data generated by the merchandise sales data processing carried out by the POS terminal 1 and stores a merchandise master or the like for use in the merchandise sales data processing.

The headquarter server 3 collects and manages merchandise information, merchandise sales information, and the like of merchandises sold by the POS terminal 1 from the POS terminal 1 or the store server 2. The headquarter server stores the merchandise master including merchandise information, such as a merchandise code, which is merchandise specifying information. The headquarter server 3 also stores a customer master including membership information, such as a membership code as reception destination specifying information for specifying a reception destination device. The headquarter server 3 also stores a point master to store privilege information, such as a point generated according to a purchase amount of items purchased by a member for each member. The headquarter server 3 stores various other kinds of information and distributes various information from the headquarter server 3 to the POS terminal 1 or the store server 2 and then to a customer or a salesperson therefrom.

The number of POS terminals 1 provided in the store P1 is not particularly limited, and a plurality of POS terminals 1 may be provided. In this embodiment, the POS terminal 1 is configured to generate and output electronic receipt data. It should be noted that the store server 2 may generate and output electronic receipt data based on receipt data generated by the POS terminal 1.

The electronic receipt management server 4 is located at an electronic receipt center P3. The electronic receipt management server 4 functions as a customer electronic receipt management server which collectively manages electronic receipt data of various companies each operating the store P1. The electronic receipt management server 4 performs membership registration through a procedure described below or the like and stores and manages membership data in a membership master held in a database DB with respect to each membership code. Membership data includes reception destination specifying information for specifying the name of a customer (member) who acquires a membership code as membership specifying information or a reception destination device of an electronic receipt as membership specifying information. Thus, the membership data includes a membership code and reception destination specifying information of the mobile terminal 7 which is a reception destination device receiving an electronic receipt, or the like. The reception destination specifying information is, for example, the membership code. A membership management server which stores and manages the membership data, or the like may be provided separately from the electronic receipt management server 4.

The electronic receipt management server 4 receives electronic receipt data transmitted from the POS terminal 1 through the network N3. The electronic receipt management server 4 stores and manages the received electronic receipt data in an electronic receipt data storage unit 442 held in the database DB with respect to each membership code.

The electronic receipt management server 4 specifies the mobile terminal 7 as a reception destination device by referring to the membership code of electronic receipt data stored in the database DB. The electronic receipt management server 4 outputs an electronic receipt generated based on the electronic receipt data stored in the database DB to the specified mobile terminal 7.

If electronic receipt inquiry information is received from the mobile terminal 7 through a network N5, the electronic receipt management server 4 generates an electronic receipt based on the corresponding electronic receipt data and outputs the electronic receipt to the mobile terminal 7. In this way, a customer may browse the electronic receipt using the mobile terminal 7.

The network N3 which connects the POS terminal 1 and the electronic receipt management server 4 is, for example, the Internet or a dedicated line, such as VPN. A transmission method of the electronic receipt data is not particularly limited, and a general-purpose protocol, such as HTTP or HTTPS, may be used. The headquarter server 3 and the electronic receipt management server 4 are connected through the network N3.

The mobile terminal 7 is a terminal device, such as a smartphone, a mobile phone, a personal digital assistance (PDA), or a tablet computer, which is used by the user of this system. The mobile terminal 7 has an application, such as a Web browser for browsing various kinds of information provided through the network N5. Instead of the mobile terminal 7, a terminal device, such as a PC, may be used.

The mobile terminal 7 accesses the electronic receipt management server 4 through the network N5 to perform membership registration in this system. The network N5 is the Internet or various public networks.

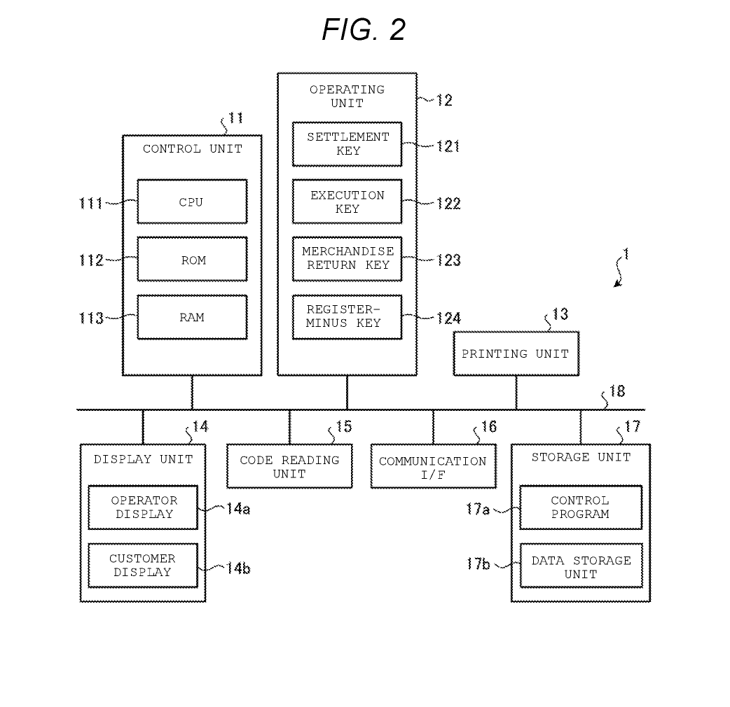

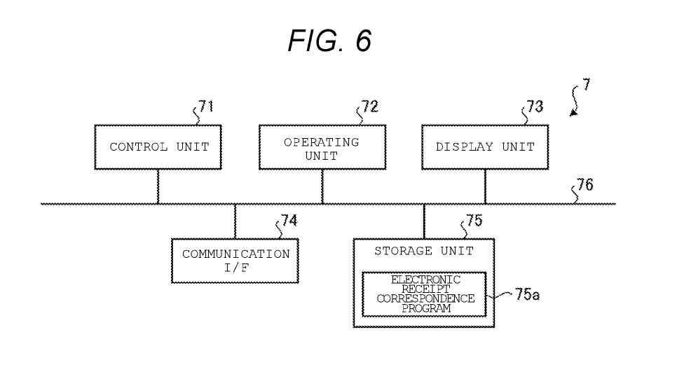

The mobile terminal 7 displays the membership code of the member on a display unit 73 (see FIG. 6) as a code symbol, such as a barcode or a two-dimensional code. The customer provides the mobile terminal 7, on which the code symbol is displayed, to a salesperson at the time of checkout in the store P1. Alternatively, the customer provides a membership card which is issued upon membership registration and on which a membership code is printed as a code symbol, such as a barcode or a two-dimensional code. The salesperson reads the code symbol printed on the membership card or displayed on the mobile terminal 7 using a code reading unit 15 (see FIG. 2) including a scanner connected to the POS terminal 1. According to this procedure, it is possible to correlate the membership code of the customer with receipt data generated upon the merchandise sales data processing in the POS terminal 1.

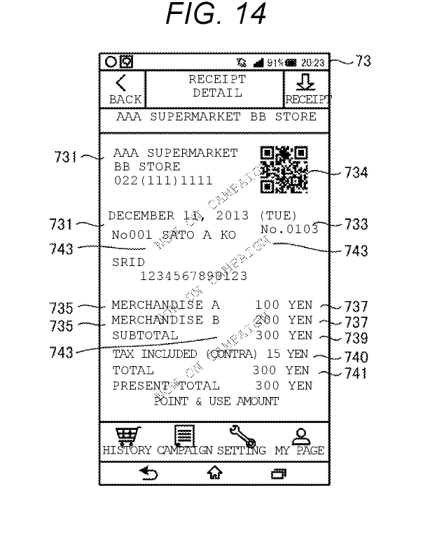

The mobile terminal 7 receives the electronic receipt of the transaction output from the electronic receipt management server 4 through the network N5 after the checkout (transaction) at the POS terminal 1. Specifically, the mobile terminal 7 transmits the electronic receipt inquiry information for designating the membership code and the transaction date to the electronic receipt management server 4 through the network N5. Then, the electronic receipt management server 4 outputs the electronic receipt generated based on electronic receipt data to the mobile terminal 7 according to the electronic receipt inquiry information of the member. The mobile terminal 7 displays the received electronic receipt on a display unit 73 described below (see FIG. 14).

In the electronic receipt system configured above, electronic receipt data representing the content of the transaction in the POS terminal 1 is transmitted directly from the POS terminal 1 to the electronic receipt management server 4. The customer designates the uniform resource locator (URL) of the mobile terminal 7 which has a function of the Web browser and browses the electronic receipt disclosed on the Web using the mobile terminal 7. An application for browsing receipt data may be installed on the mobile terminal 7 to allow the customer to browse receipt data.

Next, hardware configuration of main devices of the electronic receipt system according to the embodiment will be described with reference to FIGS. 2 to 6.

FIG. 2 is a block diagram of the POS terminal 1. As illustrated in FIG. 2, the POS terminal 1 includes a control unit 11 which performs various arithmetic operations or generally controls the respective units of the POS terminal 1. The control unit 11 is a computer which includes a central processing unit (CPU) 111, a read only memory (ROM) 112, a random access memory (RAM) 113, a real time clock (RTC) unit, and the like. The CPU 111 is a main control unit. The ROM 112 stores various programs or data. The RAM 113 temporarily stores various programs or rewritably stores various data. The RTC unit tells present date and time.

The control unit 11 is connected to an operating unit 12, a printing unit 13, a display unit 14, a code reading unit 15, a communication I/F 16, and a storage unit 17 through a bus 18.

The operating unit 12 includes various operation keys used when an operator performs an operation input. The operation keys include, for example, a settlement key 121, an execution key 122, a merchandise return key 123, and a register-minus key 124, in addition to the numeric keys for inputting numerical values. The settlement key 121 is a key which is operated when a purchase transaction with a customer ends. The execution key 122 is a key for executing merchandise return processing or register-minus processing.

The merchandise return processing is processing for returning all or some of items purchased by a customer after the purchase transaction ends. The register-minus processing is processing which is executed when the transaction is cancelled after the purchase transaction ends or when some items in the transaction are cancelled (equivalent to return items) after the purchase transaction ends. The merchandise return key 123 is a key which is operated when the merchandise return processing starts in the POS terminal 1. The register-minus key 124 is a key which is operated when the register-minus processing is operated in the POS terminal 1.

The printing unit 13 includes a printer which performs printing a receipt or a journal. The printing unit 13 includes a cutting mechanism (not illustrated) which cuts a sheet, such as roll paper, which is a printing medium, according to a cut command described below.

The display unit 14 is, for example, a liquid crystal display, and displays various kinds of information, such as the merchandise name and price of an item registered for sale, a total price of one transaction, a change amount, and the like. The display unit 14 includes an operator display 14a which displays various kinds of information for a cashier, and a customer display 14b which displays various kinds of information for a customer. The display unit 14 may include a touch panel, and in this case, the touch panel functions as the operating unit 12.

The code reading unit 15 is a scanner device which optically reads a code symbol, such as a barcode or a two-dimensional code. For example, the code reading unit 15 reads a code symbol appended to an item for sale, a code symbol printed on the membership card, a code symbol displayed on the mobile terminal 7, or the like. The control unit 11 receives information indicated by the read code symbol as an input. The code symbol appended to the item for sale indicates a merchandise code for specifying the item, or the like. A code symbol displayed on the mobile terminal 7 indicates a membership code (customer code) which is reception destination specifying information for specifying a reception destination device that receives an electronic receipt. The membership code may be magnetically or electrically stored in the membership card or the mobile terminal 7. In this case, the stored membership code is read by a dedicated reading device. The control unit 11 receives the membership code as an input.

The control unit 11 is connected to the communication interface (I/F) 16 through the bus 18. The control unit 11 is connectable to the network N1 in the store P1, the network N2, or the network N3 through the communication I/F 16.

The control unit 11 is connected to the storage unit 17 through the bus 18. The storage unit 17 is, for example, an auxiliary storage device, such as a hard disk drive (HDD) or a solid state drive (SSD). The storage unit 17 stores a control program 17a for executing various POS processing including merchandise sales data processing. The storage unit 17 stores various data files pertaining to the merchandise sales data processing, such as a merchandise master including merchandise data, such as the merchandise name, the merchandise code, and the unit price of the of each item for sale. The storage unit 17 includes a data storage unit 17b which stores the membership code received from the code symbol, a transaction number, a merchandise code of an item to be returned, and the like.

The storage unit 17 stores a POS terminal number, a company code, business type and business category code, a store code, and the like in the data storage unit 17b. The POS terminal number is unique to each of the POS terminals 1 and different from other POS terminals 1. The company code is an identification code of a company which operates the headquarter P2 or the store P1. The store code represents the store P1 in which the POS terminal 1 is provided. The business type and business category code is a code (classification code) which classifies the business type and business category of a store into a convenience store, a supermarket, a department store, a pharmacy, a restaurant, an eating house, and the like. The business type and business category may be arbitrarily changed according to the preference of the user. The company code (an identification code of a company which operates the store P1) and the business type and business category code may be registered in the headquarter server 3.

The storage unit 17 stores a receipt data schema (not illustrated) which describes a conversion rule that is used when receipt data in an unstructured format is converted to electronic receipt data in a structured format.

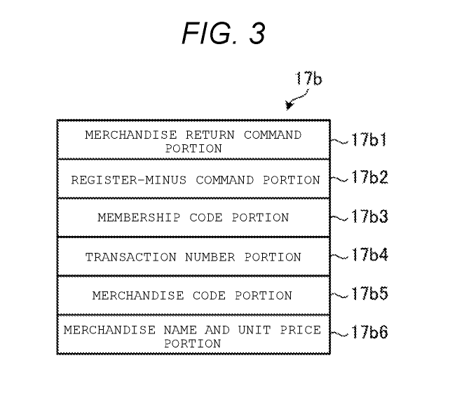

The data storage unit 17b of the storage unit 17 stores various kinds of information when executing merchandise return processing or register-minus processing. The details will be described with referring to FIG. 3.

FIG. 3 illustrates structure of the data storage unit 17b. The data storage unit 17b includes a merchandise return command portion 17b1, a register-minus command portion 17b2, a membership code portion 17b3, a transaction number portion 17b4, a merchandise code portion 17b5, and a merchandise name and unit price portion 17b6.

The merchandise return command portion 17b1 stores a merchandise return command for executing the merchandise return processing which is generated when the merchandise return key 123 is operated. The register-minus command portion 17b2 stores a register-minus command for executing the register-minus processing which is generated when the register-minus key 124 is operated. The membership code portion 17b3 stores a membership code which is input during the merchandise return processing or the register-minus processing. The transaction number portion 17b4 stores a transaction number which is input during the merchandise return processing or the register-minus processing and specifies a transaction. The transaction number is, for example, information of a part of electronic receipt data, and is an electronic receipt number which specifies electronic receipt data for each transaction. The merchandise code portion 17b5 stores the merchandise code of an item which is returned through the merchandise return processing or an item which is cancelled through the register-minus processing. The merchandise name and unit price portion 17b6 stores the merchandise name and the unit price of the item which is returned through the merchandise return processing or the item which is cancelled through the register-minus processing.

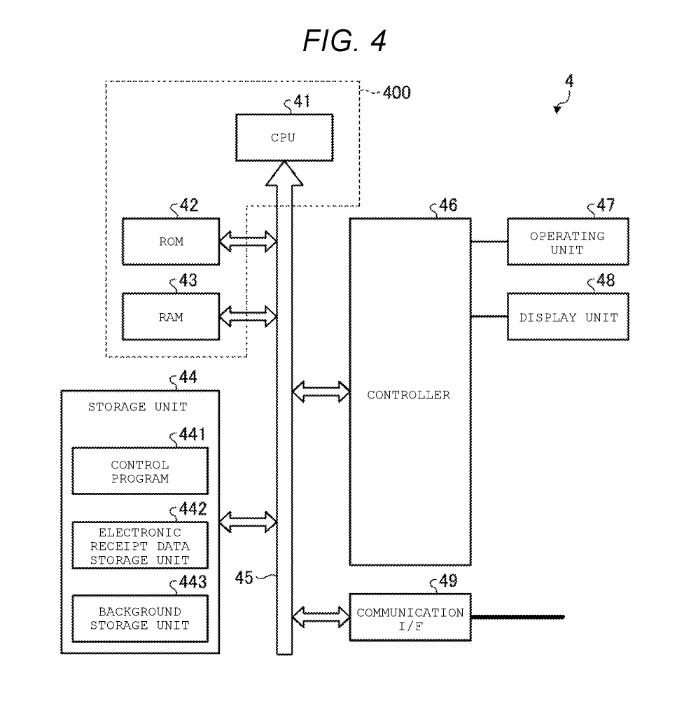

Next, the configuration of the electronic receipt management server 4, which functions as a customer receipt management server, will be described with referring to a block diagram of FIG. 4. The electronic receipt management server 4 includes a CPU 41, a ROM 42, a RAM 43, a storage unit 44, and the like. The CPU 41 is a main control unit. The ROM 42 stores various programs. The RAM 43 develops various data. The storage unit 44 stores various programs. The CPU 41, the ROM 42, the RAM 43, and the storage unit 44 are connected with each other through a data bus 45. The CPU 41, the ROM 42, and the RAM 43 configure a control unit 400. The control unit 400 is configured such that the CPU 41 operates according to a control program 441 stored in the ROM 42 or the storage unit 44 and developed on the RAM 43, thereby executing control processing described below.

An operating unit 47 and a display unit 48 are connected to the data bus 45 through a controller 46. The operating unit 47 includes numeric keys for inputting numerals, various function keys, and the like. The display unit 48 displays various kinds of information pertaining to the control of electronic receipt data which is executed by the electronic receipt management server 4.

The control unit 400 is connectable to the network N3 and the network N5 through the communication I/F 49 connected to the data bus 45. The control unit 400 is connected to the storage unit 44 through the data bus 45.

The storage unit 44 includes a membership master management unit (not illustrated) which stores and manages the membership master. The storage unit 44 includes electronic receipt data storage unit 442 which collectively stores electronic receipt data of various companies each operating the store P1. In more detail, the electronic receipt data storage unit 442 manages electronic receipt data of various companies each operating the store P1 with respect to each membership code.

The storage unit 44 includes a background storage unit 443 which stores background information (additional information) of an electronic receipt to be displayed on the mobile terminal 7. The background storage unit 443 stores background information, such as patterns, photographs, or watermark characters 743 as the background to be displayed on the mobile terminal 7. The background information is associated with the electronic receipt data, whereby it is possible to change the background of an electronic receipt to be displayed on the mobile terminal 7. The background information is information other than the merchandise information included in electronic receipt data. The additional information includes strike-through information indicating that the merchandise return processing or the register-minus processing is executed. The strike-through information is displayed to overlap the merchandise information of an item subjected to the merchandise return processing or the register-minus processing.

Electronic receipt data includes the membership code, the company code, the store code, the POS number of the POS terminal 1, the transaction number, the merchandise information, the merchandise sales data (including date and time data), and the like.

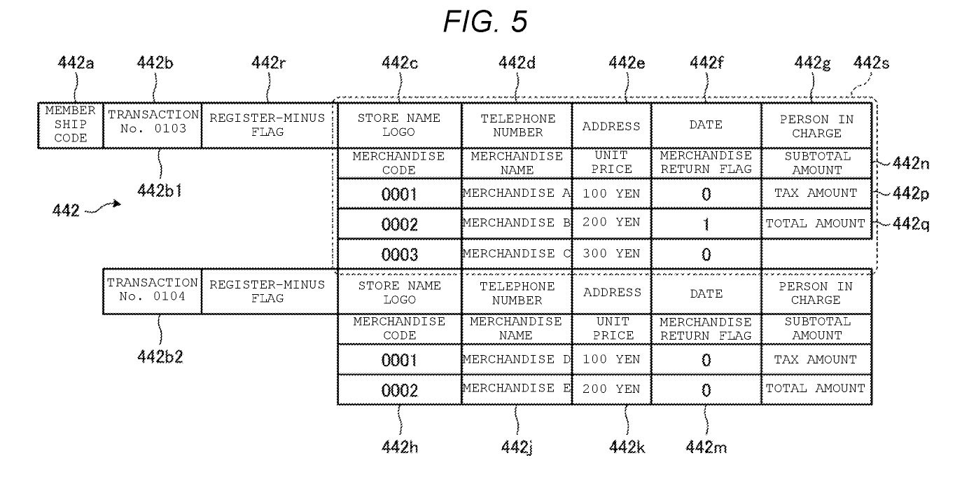

Next, the electronic receipt data storage unit 442 will be described in detail referring to FIG. 5. Electronic receipt data includes the following information stored in the electronic receipt data storage unit 442 with respect to each membership code. That is, the electronic receipt data storage unit 442 includes a membership code portion 442a. The electronic receipt data storage unit 442 further includes a transaction number portion 442b, a store name logo portion 442c, a telephone number portion 442d, an address portion 442e, a date portion 442f, a person in charge portion 442g, a merchandise code portion 442h, a merchandise name portion 442j, a unit price portion 442k, a merchandise return flag portion 442m, a subtotal amount portion 442n, a tax amount portion 442p, a total amount portion 442q, and a register-minus flag portion 442r corresponding to the membership code portion 442a.

The membership code portion 442a stores a membership code which specifies a member. The transaction number portion 442b stores a transaction number of a transaction carried out by the member which is specified by the membership code. The transaction number is a number for specifying the transaction, and is also an electronic receipt number which specifies the electronic receipt. In FIG. 5, transactions of two transaction numbers of the transaction number “0103” of the transaction number portion 442b1 and the transaction number “0104” of the transaction number portion 442b2 are stored corresponding to one membership code. In FIG. 5, for simplification of description, a company code representing a company is omitted. In order to specify a company, which carries a transaction, as well as the transaction, the company code is also stored in the transaction number portion 442b.

The store name logo portion 442c stores the logo of the store P1 which carries out the transaction processing. The telephone number portion 442d stores the telephone number of store P1. The address portion 442e stores the address of the store P1. The date portion 442f stores the date on which the transaction is carried out. The person in charge portion 442g stores the name of person in charge, who carries out the transaction operation.

The merchandise code portion 442h stores a merchandise code which specifies an item purchased in the transaction. The merchandise name portion 442j stores the merchandise name of the item purchased in the transaction. The unit price portion 442k stores the unit price of the item purchased in the transaction.

The merchandise return flag portion 442m stores a merchandise return flag indicating whether or not a purchased item is subjected to the merchandise return processing.

as the merchandise return flag stored in the merchandise return flag portion 442m indicates that the merchandise return processing has been performed. “0” as the merchandise return flag stored in the merchandise return flag portion 442m indicates that the merchandise return processing has not been performed. In FIG. 5, with respect to a merchandise A, a merchandise C, a merchandise D, and a merchandise E, since the merchandise return flag of the merchandise return flag portion 442m is “0,” the merchandise return processing has not been performed. In contrast, for a merchandise B, since the merchandise return flag of the merchandise return flag portion 442m is “1,” the merchandise return processing is executed in the POS terminal 1.

The subtotal amount portion 442n stores a subtotal obtained by totaling the prices of items purchased in the transaction. The tax amount portion 442p stores an amount of sales tax on the subtotal. In FIG. 5, the tax is included in the subtotal. The total amount portion 442q stores a total price calculated based on the subtotal and the tax. In the example of FIG. 5, since a tax is included in the subtotal, the subtotal is equal to the total price.

When a transaction number as register-minus data is received from the POS terminal 1 in which the register-minus processing is executed, the register-minus flag portion 442r stores a register-minus flag “1” correlating the transaction number with a transaction number stored in the transaction number portion 442b. A transaction for which the register-minus flag is set to “1” is logically deleted. The electronic receipt management server 4 does not output the electronic receipt of the logically deleted transaction. The mobile terminal 7 does not receive the electronic receipt of the logically deleted transaction. Logical deletion means that, while transaction data remains without being deleted actually, data is logically deleted.

When a merchandise code of an item to be cancelled is received as register-minus data, the merchandise return flag of the merchandise return flag portion 442m regarding the item specified by the merchandise code is set to “1”. Also when a merchandise name and a unit price are received as register-minus data, the merchandise return flag of the merchandise return flag portion 442m regarding an item specified by the merchandise name and the unit price is set to “1.”

In FIG. 5, data stored in the electronic receipt data storage unit 442 is for one membership code. Actually, the electronic receipt data storage unit 442 stores data for a plurality of membership codes, and stores data for one or more transactions in association with each membership code.

Next, the configuration of the mobile terminal 7 will be described with referring to a block diagram of FIG. 6. As illustrated in FIG. 6, the mobile terminal 7 includes a control unit 71 which performs various arithmetic operations or generally controls the respective units of the mobile terminal 7. The control unit 71 is a computer which includes a CPU, a ROM, a RAM, a RTC unit, and the like.

An operating unit 72 is connected to a display unit 73 through a bus 76. The operating unit 72 includes various operation keys that are used when a customer (member) performs an operation input, and a pointing device. The display unit 73 is, for example, a liquid crystal display, and displays various kinds of information, such as an electronic receipt described below. The display unit 73 includes a touch panel, and in this case, the touch panel functions as the operating unit 72.

The control unit 71 is connected to a communication I/F 74 through the bus 76, and is connectable to the network N5 through the communication I/F 74. Connection to the network N1 in the store P1 may be possible through the communication I/F 74.

The control unit 71 is connected to a storage unit 75 through the bus 76. The storage unit 75 stores a Web browser for browsing various kinds of information (contents) disclosed on the Web. The storage unit 75 stores an electronic receipt correspondence program 75a which is used to receive an electronic receipt from the electronic receipt management server 4 and display the electronic receipt.

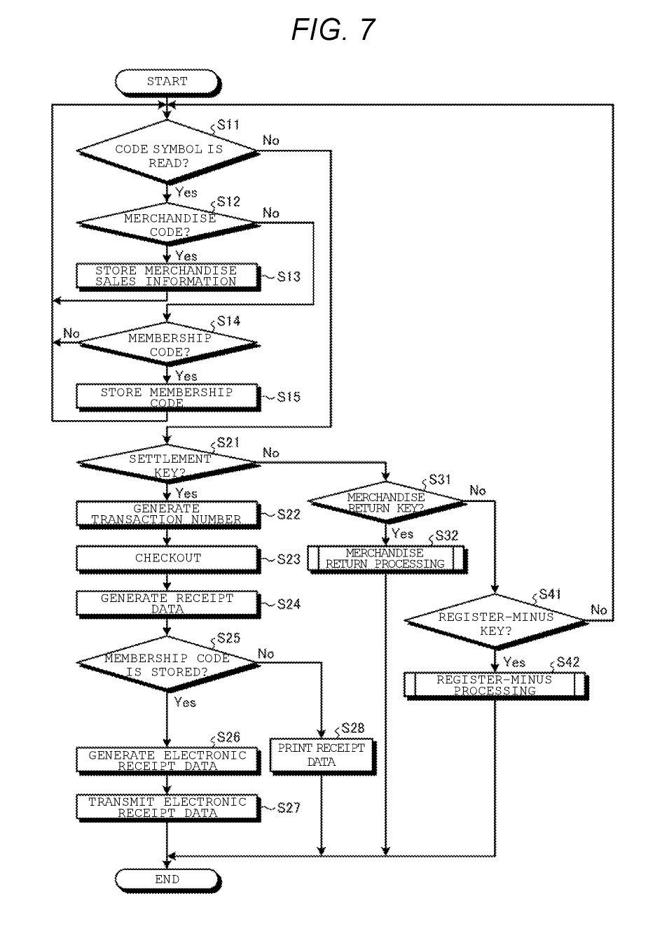

Next, control processing of the respective units configuring the system of this embodiment will be described with referring to FIGS. 7 to 15.

First, the flow of electronic receipt data generation processing, merchandise return processing, and register-minus processing carried out by the POS terminal 1 will be described with referring to flowcharts illustrated in FIGS. 7 to 9.

FIG. 7 is a flowchart of the electronic receipt data processing, which is executed when the control unit 11 of the POS terminal 1 operates according to the control program 17a.

In FIG. 7, the control unit 11 determines whether or not a code symbol is read by the code reading unit 15 (Step S11). Here, “Step S” is simply described as “S” in FIG. 7. When it is determined that the code symbol is read (Yes in S11), the control unit 11 determines whether or not the read code symbol is a merchandise code (S12). The merchandise code has a code representing a country, a code representing an item for sale, and the like, and the control unit 11 determines whether or not the code symbol is a merchandise code using this code system.

When it is determined that the read code symbol is a merchandise code (Yes in S12), the control unit 11 reads merchandise information from a merchandise master (not illustrated) corresponding to the merchandise code included in the read code symbol. The control unit 11 stores the read merchandise information in the data storage unit 17b (S13). Then, the control unit 11 returns to S11 and is in a standby state.

When it is determined that the read code symbol is not a merchandise code (No in S12), then the control unit 11 determines whether or not the read code symbol is a membership code (S14). When it is determined that the code symbol is a membership code (Yes of S14), the control unit 11 stores the membership code in the data storage unit 17b (S15). Then, the control unit 11 returns to S11 and is in a standby state. When it is determined that the code symbol is not a membership code (No in S14), the control unit 11 returns to S11 and is in a standby state.

In S11, when it is determined that the code symbol is not read (No in S11), the control unit 11 determines whether or not the settlement key 121 of the operating unit 12 is operated (S21). When it is determined that the settlement key 121 is operated (Yes in S21), the control unit 11 determines that the transaction is established and generates a transaction number (S22). The control unit 11 executes checkout processing based on the generated transaction number, the total price of the transaction, and the like (S23).

Next, the control unit 11 generates receipt data pertaining to the transaction based on transaction information subjected to the checkout processing (S24). Receipt data includes merchandise information including the merchandise name and price of each purchased item, checkout information including a total price and a change amount, and the like. In S15, when the membership code is stored, the membership code is also included in receipt data.

Next, the control unit 11 determines whether or not the membership code is included in the generated receipt data (S25). When it is determined that the membership code is included (Yes in S25), the control unit 11 generates electronic receipt data based on receipt data generated in S24 (S26). Electronic receipt data in the embodiment is information including the items (442a to 442r) illustrated in FIG. 5, such as the membership code, the transaction number, and the merchandise code. Electronic receipt data includes a store code which specifies a store, a company code which specifies a company that operates the store, and the like. The control unit 11 transmits generated electronic receipt data directly to the electronic receipt management server 4 through the network N3 (S27). Then, the control unit 11 ends the processing.

When it is determined that the membership code is not included (No in S25), the control unit 11 controls the printing unit 13 to print a receipt based on the generated receipt data (S28). Then, the control unit 11 ends the processing.

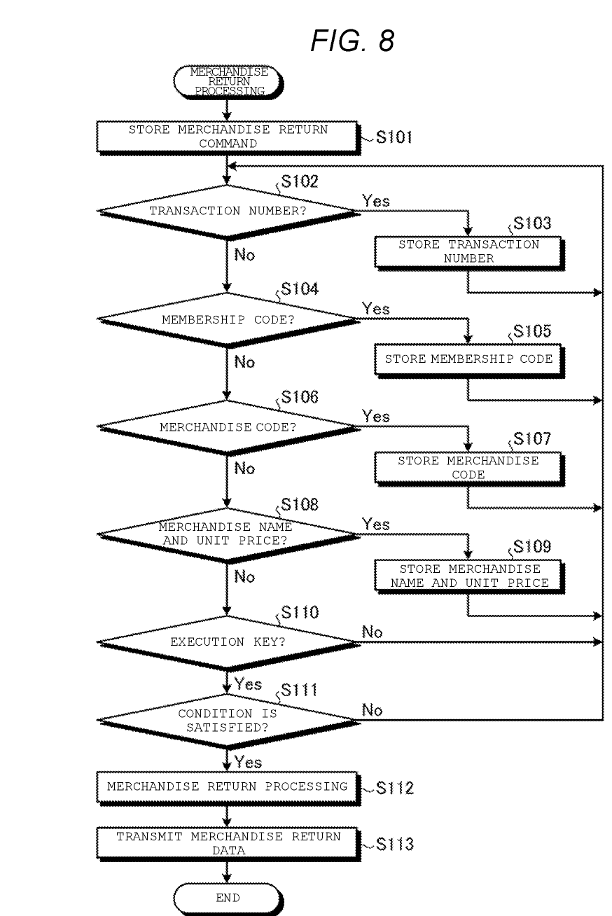

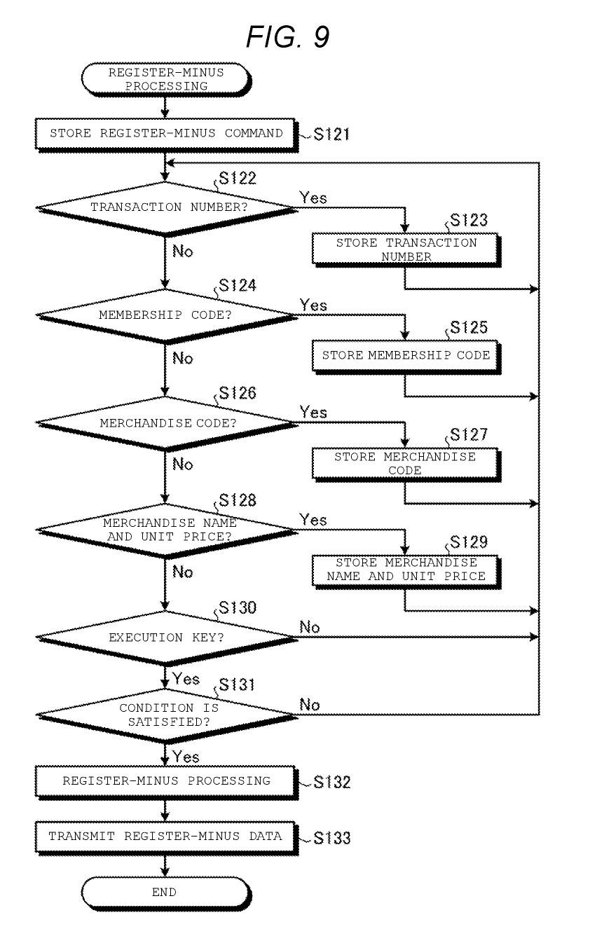

In S21, when it is determined that there is no operation of the settlement key 121 (No in S21), the control unit 11 determines whether or not the merchandise return key 123 is operated (S31). When it is determined that the merchandise return key 123 is operated (Yes in S31), the control unit 11 executes the merchandise return processing illustrated in FIG. 8 (S32). Then, the control unit 11 ends the processing. When it is determined that the merchandise return key 123 is not operated (No in S31), the control unit 11 determines whether or not the register-minus key 124 is operated (S41). When it is determined that the register-minus key 124 is operated (Yes in S41), the control unit 11 executes the register-minus processing illustrated in FIG. 9 (S42). Then, the control unit 11 ends the processing. When it is determined that the register-minus key 124 is not operated (No in S41), the control unit 11 returns to S11.

Next, the merchandise return processing of S32 will be described in detail with reference to a flowchart of FIG. 8. In FIG. 8, the control unit 11 stores, in the merchandise return command portion 17b1, a merchandise return command generated when the merchandise return key 123 is operated (S101). Next, the control unit 11 determines whether or not a transaction number is input through the operating unit 12 or the code reading unit 15 (S102). When it is determined that the transaction number is input (Yes in S102), the control unit 11 stores the input transaction number in the transaction number portion 17b4 (S103). Then, the control unit 11 returns to S102 and is in a standby state.

When it is determined that the transaction number is not input (No of S102), then the control unit 11 determines whether or not a membership code is input through the code reading unit 15 (S104). When it is determined that the membership code is input (Yes in S104), the control unit 11 stores the input membership code in the membership code portion 17b3 (S105). Then, the control unit 11 returns to S102 and is in a standby state.

When it is determined that the membership code is not input (No in S104), then the control unit 11 determines whether or not a merchandise code is input through the code reading unit 15 (S106). When it is determined that the merchandise code is input (Yes in S106), the control unit 11 stores the input merchandise code in the merchandise code portion 17b5 (S107). Then, the control unit 11 returns to S102 and is in a standby state.

When it is determined that the merchandise code is not input (No in S106), the control unit 11 determines whether or not a merchandise name and a unit price are input through the operating unit 12 (S108). When it is determined that the merchandise name and the unit price are input (Yes in S108), the control unit 11 stores the input merchandise name and unit price in the merchandise name and unit price portion 17b6 (S109). When it is determined that the merchandise name and the unit price are not input (No in S108), the control unit 11 determines whether or not the execution key 122 is operated (S110). The execution key 122 is operated when the merchandise return processing is executed.

When it is determined that the execution key 122 is operated (Yes in S110), the control unit 11 determines whether or not a condition for executing the merchandise return processing is satisfied (S111). When at least one of the transaction number and the membership code and one of the merchandise code and a pair of the merchandise name and the unit price of an item to be returned are stored in the data storage unit 17b, the control unit 11 determines that the condition for executing the merchandise return processing is satisfied.

When it is determined that the condition for executing the merchandise return processing is satisfied (Yes in S111), the control unit 11 executes the merchandise return processing (S112). The merchandise return processing refers to processing for deleting sales data of returned items from sales data stored in the POS terminal 1 or the store server 2 to update a memory.

The control unit 11 transmits, to the headquarter server 3 and the electronic receipt management server 4, at least one of the transaction number and the membership code, one of the merchandise code, the merchandise name, and the unit price, and the merchandise return command instructing that the merchandise return processing be executed (S113). At least one of the transaction number and the membership code, one of the merchandise code and a pair of the merchandise name and the unit price, and the merchandise return command are collectively referred to as “merchandise return data.”

In S110, when it is determined that the execution key 122 is not operated (No in S110), the control unit 11 returns to S102 and is in a standby state. In S111, when it is determined that the condition for executing the merchandise return processing is not satisfied (No in S111), the control unit 11 returns to S102 and is in a standby state.

Next, the register-minus processing of S42 will be described in detail with reference to a flowchart of FIG. 9. In FIG. 9, the control unit 11 stores a register-minus command, which is generated when the register-minus key 124 is operated, in the register-minus command portion 17b2 (S121). Next, the control unit 11 determines whether or not a transaction number is input through the operating unit 12 or the code reading unit 15 (S122). When it is determined that the transaction number is input (Yes in S122), the control unit 11 stores the input transaction number in the transaction number portion 17b4 (S123). Then, the control unit 11 returns to S122 and is in a standby state.

When it is determined that the transaction number is not input (No in S122), then the control unit 11 determines whether or not a membership code is input through the code reading unit 15 (S124). When it is determined that the membership code is input (Yes in S124), the control unit 11 stores the input membership code in the membership code portion 17b3 (S125). Then, the control unit 11 returns to S122 and is in a standby state.

When it is determined that the membership code is not input (No in S124), then the control unit 11 determines whether or not a merchandise code is input through the code reading unit 15 (S126). When it is determined that the merchandise code is input (Yes in S126), the control unit 11 stores the input merchandise code in the merchandise code portion 17b5 (S127). Then, the control unit 11 returns to S122 and is in a standby state.

When it is determined that the merchandise code is not input (No in S126), the control unit 11 determines whether or not a merchandise name and a unit price are input through the operating unit 12 (S128). When it is determined that the merchandise name and the unit price are input (Yes in S128), the control unit 11 stores the input merchandise name and unit price in the merchandise name and unit price portion 17b6 (S129). When it is determined that the merchandise name and the unit price are not input (No in S128), the control unit 11 determines whether or not the execution key 122 is operated (S130). The execution key 122 is operated when the register-minus processing is executed.

When it is determined that the execution key 122 is operated (Yes in S130), the control unit 11 determines whether or not a condition for executing the register-minus processing is satisfied (S131). When a transaction number is stored in the data storage unit 17b, the control unit 11 determines that the condition for executing the register-minus processing is satisfied. Also when a membership code, and one of a merchandise code and a pair of a merchandise name and a unit price of an item to be subjected to the register-minus processing are stored, the control unit 11 determines that the condition for executing the register-minus processing is satisfied.

When it is determined that the condition for executing the register-minus processing is satisfied (Yes in S131), the control unit 11 executes the register-minus processing based on the stored transaction number (S132). Alternatively, the register-minus processing is executed based on the membership code and the merchandise code or the membership code and the merchandise name and unit price (S132). The register-minus processing refers to processing for deleting merchandise sales data of a transaction or item subjected to the register-minus processing from merchandise sales data stored in the POS terminal 1 or the store server 2 to update a memory. The register-minus processing includes processing for cancelling the entire transaction and processing for cancelling some items. The processing for canceling some items is substantially the same as the merchandise return processing.

The control unit 11 transmits a pair of the transaction number and the register-minus command, a group of the membership code, the merchandise code, and the register-minus command, or a group of the membership code, the merchandise name, the unit price, and the register-minus command, to the headquarter server 3 and the electronic receipt management server 4 (S133). The pair of the transaction number and the register-minus command is referred to as “register-minus data.” The group of the membership code, the merchandise code, and the register-minus command are also referred to as “register-minus data.” The group of the membership code, the merchandise name, the unit price, and the register-minus command are also collectively referred to as “register-minus data.”

In S130, when it is determined that the execution key 122 is not operated (No in S130), the control unit 11 returns to S122 and is in a standby state. In S131, when it is determined that the condition for executing the register-minus processing is not satisfied (No in S131), the control unit 11 returns to S122 and is in a standby state.

Next, the flow of electronic receipt management processing, which is executed when the control unit 400 of the electronic receipt management server 4 operates according to the control program 441, will be described.

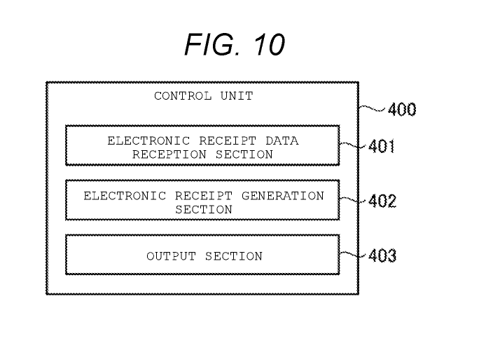

FIG. 10 is a functional block diagram of the electronic receipt management server 4. The control program 441 which is executed by the electronic receipt management server 4 includes an electronic receipt data reception section 401, an electronic receipt generation section 402, and an output section 403. The CPU 41 reads the control program 441 from the storage unit 44 and executes the control program 441, and whereby the control unit 400 achieves the electronic receipt data reception section 401, the electronic receipt generation section 402, and the output section 403.

The electronic receipt data reception section 401 has a function of receiving electronic receipt data generated based on merchandise information of transacted items.

The electronic receipt generation section 402 has a function of generating an electronic receipt having additional information, which is information other than the merchandise information, appended to the electronic receipt data received by the electronic receipt data reception section 401.

The output section 403 has a function of outputting the electronic receipt generated by the electronic receipt generation section 402 to a reception destination device specified by reception destination specifying information of the electronic receipt.

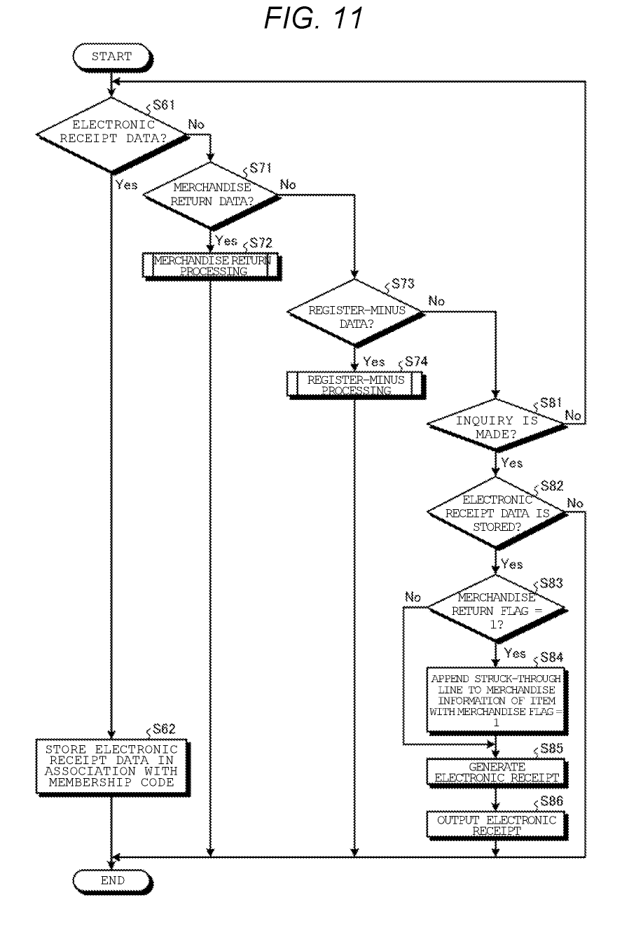

FIG. 11 is a flowchart illustrating control processing carried out by the electronic receipt management server 4. In FIG. 11, the control unit 400 (electronic receipt data reception section 401) determines whether or not electronic receipt data generated by the POS terminal 1 is received from the POS terminal 1 (S61). When it is determined that electronic receipt data is received (Yes in S61), the control unit 400 stores electronic receipt data in the electronic receipt data storage unit 442 in association with a membership code included in the received electronic receipt data (S62). Then, the control unit 400 ends the processing.

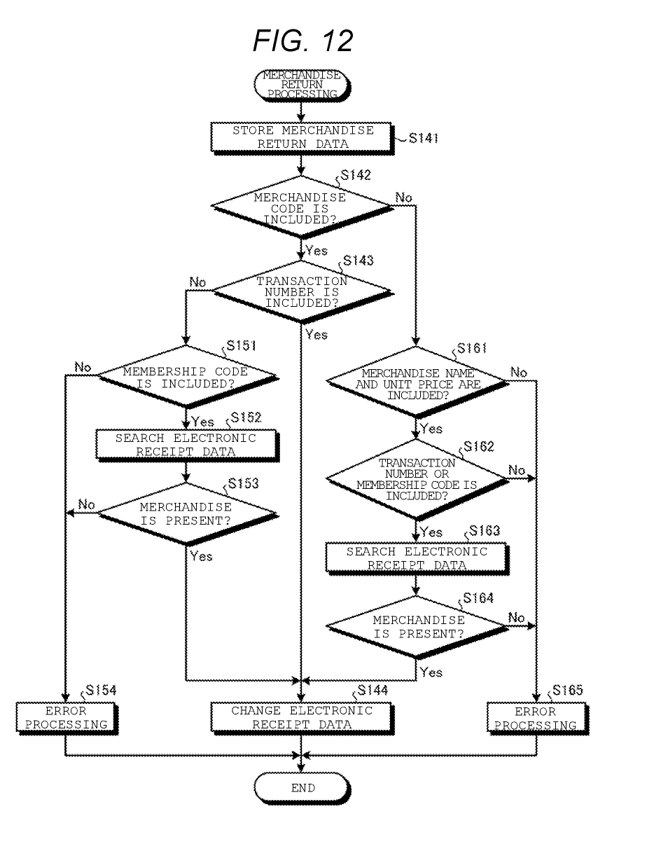

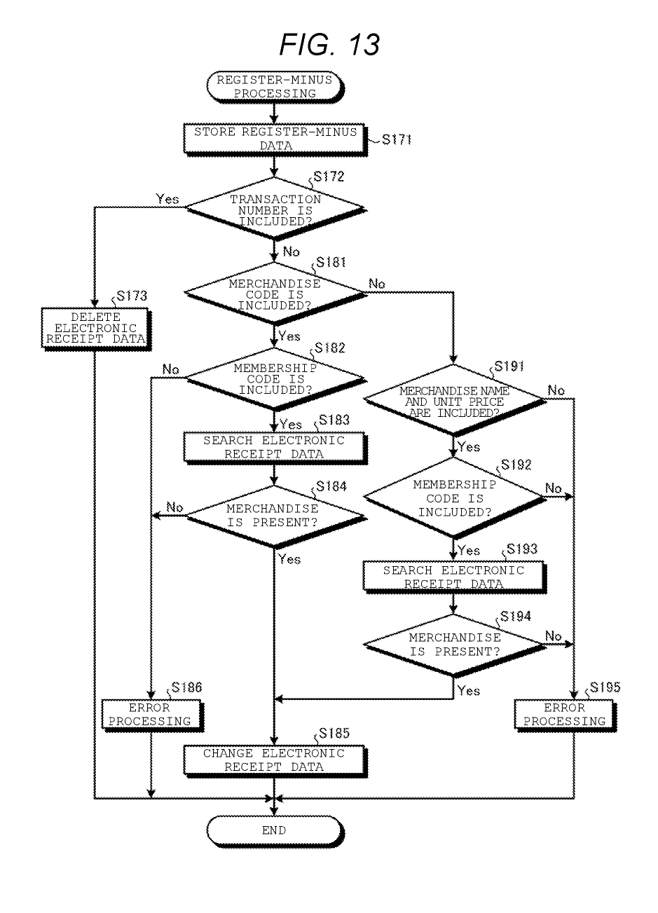

When it is determined that electronic receipt data is not received (No in S61), the control unit 400 determines whether or not merchandise return data is received from the POS terminal 1 (S71). When it is determined that merchandise return data is received (Yes in S71), the control unit 400 executes the merchandise return processing illustrated in FIG. 12 (S72). When it is determined that merchandise return data is not received (No in S71), the control unit 400 determines whether or not register-minus data is received (S73). When it is determined that register-minus data is received (Yes in S73), the control unit 400 executes the register-minus processing illustrated in FIG. 13 (S74).

When it is determined that register-minus data is not received (No in S73), the control unit 400 determines whether or not an electronic receipt is inquired from the mobile terminal 7 (S81). An inquiry is made from the mobile terminal 7 based on the membership code and date.

When it is determined that the inquiry is made (Yes in S81), the control unit 400 determines whether or not the corresponding electronic receipt data is stored in the electronic receipt data storage unit 442 (S82). When the register-minus processing is executed based on the transaction number, since the transaction is cancelled, the corresponding electronic receipt data is logically deleted. In this case, the control unit 400 determines that electronic receipt data is not stored in the electronic receipt data storage unit 442.

When it is determined that electronic receipt data is stored in the electronic receipt data storage unit 442 (Yes in S82), the control unit 400 determines whether or not the merchandise return flag “1” is stored in the merchandise return flag portion 442m of the corresponding electronic receipt data (S83). When it is determined that the merchandise return flag “1” is stored (Yes in S83), the control unit 400 reads the corresponding electronic receipt data from the electronic receipt data storage unit 442 and appends strike-through information, which is additional information, on the merchandise information, in which the merchandise return flag “1” is stored (S84).

The control unit 400 (electronic receipt generation section 402) generates an electronic receipt appended with the strike-through information as the additional information (S85). In the embodiment, in S85, when generating the electronic receipt, the control unit 400 reads watermark character information (additional information) of “now on campaign” as background information from the background storage unit 443 and appends the watermark character information. Watermark characters 743 are displayed on the display unit 73 of the mobile terminal 7 as a part of the background information. The control unit 400 (output section 403) outputs the electronic receipt to the mobile terminal 7 which made the inquiry (S86). Then, the control unit 400 ends the processing. The mobile terminal 7 which receives the electronic receipt displays the electronic receipt, and whereby the customer may browse the electronic receipt.

When it is determined that the merchandise return flag “1” is not stored in the merchandise return flag portion 442m of the electronic receipt data (No in S83), the control unit 400 executes S85 without executing S84. In S82, when it is determined that electronic receipt data is not stored in the electronic receipt data storage unit 442 (No in S82), the control unit 400 ends the processing.

The background information which is appended to the electronic receipt data may be changed as necessary. For example, background information representing respective promotional campaigns suitable for the attribute of the customers, such as the age, gender, preference, and the like, may be set in the background storage unit 443 in advance, and the background information suitable for each customer may be read. The additional information may be sound, such as music or a message output from the mobile terminal 7, in addition to background display images or characters displayed on the display unit 73. For example, music which is used as sales promotion may be output when the mobile terminal 7 displays the electronic receipt.

With regard to the watermark characters 743 as the background information, arbitrary characters may be created by operating the operating unit 47 of the electronic receipt management server 4. Information (for example, patterns, contents, or the like) other than watermark characters may be appended as background information.

Next, the merchandise return processing, which is executed in S72, will be described with reference to FIG. 12. In FIG. 12, the control unit 400 stores merchandise return data received from the POS terminal 1 in the storage unit 44 (S141). Next, the control unit 400 determines whether or not a merchandise code is included in the stored merchandise return data (S142). When it is determined that the merchandise code is included (Yes in S142), the control unit 400 determines whether or not a transaction number is included in the stored merchandise return data (S143).

When it is determined that the transaction number is included (Yes in S143), the control unit 400 changes the merchandise return flag with respect to the item stored in the merchandise return flag portion 442m to “1” (S144). The control unit 400 subtracts the unit price of the item for which the merchandise return flag is set to “1,”, and changes the subtotal of the subtotal portion 442n, the tax of the tax portion 442p, and the total price of the total price portion 442q.

When it is determined that the transaction number is not included (No of S143), the control unit 400 determines whether or not a membership code is included in merchandise return data stored in S141 (S151). When it is determined that the membership code is included (Yes in S151), the control unit 400 searches the presence or absence of the corresponding item for the entire electronic receipt data associated with the membership code (S152). As a result of the search, it is determined whether or not there is the corresponding item (S153). When it is determined that there is the corresponding item (Yes in S153), the control unit 400 executes the processing of S144 on the item.

It should be noted that, in S151, when it is determined that the membership code is not included in the stored merchandise return data (No in S151), the control unit 400 executes error processing (S154). In S153, when it is determined that there is no corresponding item (No in S153), the control unit 400 executes the error processing (S154). Then, the control unit 400 ends the processing.

In S142, when it is determined that the merchandise code is not included (No in S142), the control unit 400 determines whether or not a merchandise name and a unit price of an item are included in merchandise return data (S161). When it is determined that the merchandise name and the unit price of the item are included (Yes in S161), the control unit 400 determines whether or not one of the transaction number and the membership code is included (S162).

When it is determined that one of the transaction number and the membership code is included (Yes in S162), the control unit 400 searches the presence or absence of the item of the corresponding merchandise code for electronic receipt data corresponding to the included transaction number or membership code (S163). As a result of the search, it is determined whether or not there is the corresponding item (S164). When it is determined that there is the corresponding item (Yes in S164), the control unit 400 executes the processing of S144 on the item.

In S161, when it is determined that the merchandise name and the unit price are not included (No in S161), the control unit 400 executes the error processing (S165). In S162, when it is determined that neither the transaction number nor the membership code is included in the stored merchandise return data (No in S162), the control unit 400 executes the error processing (S165). In S164, when it is determined that there is no corresponding item (No in S164), the control unit 400 executes the error processing (S165). Then, the control unit 400 ends the processing.

Next, the register-minus processing which is executed in S74 will be described with reference to FIG. 13. In FIG. 13, the control unit 400 stores register-minus data received from the POS terminal 1 in the storage unit 44 (S171). Next, the control unit 400 determines whether or not a transaction number is included in the stored register-minus data (S172). When it is determined that the transaction number is included (Yes in S172), the control unit 400 sets the register-minus flag stored in the register-minus flag portion 442r to “1” corresponding to the transaction number. When the register-minus flag is set to “1,” the transaction of the transaction number is logically deleted (S173). Specifically, electronic receipt data corresponding to the transaction number surrounded by reference numeral 442s is logically deleted. The membership code, the transaction number, and the like may be added to electronic receipt data to be logically deleted. Then, the control unit 400 ends the processing. The logically deleted electronic receipt data is not output as an electronic receipt.

In S172, when it is determined that the transaction number is not included in the register-minus data (No in S172), the control unit 400 determines whether or not a merchandise code is included in register-minus data (S181). When it is determined that the merchandise code is included (Yes in S181), the control unit 400 determines whether or not a membership code is included in register-minus data stored in S171 (S182). When it is determined that the membership code is included (Yes in S182), the control unit 400 searches the presence or absence of the item of the corresponding merchandise code with respect to the entire electronic receipt data associated with the membership code (S183). As a result of the search, it is determined whether or not there is the corresponding item (S184). When it is determined that there is the corresponding item (Yes in S184), the control unit 400 changes the merchandise return flag of the merchandise return flag portion 442m of the corresponding item to “1” (S185).

In S182, when it is determined that the membership code is not included in register-minus data (No in S182), the control unit 400 executes the error processing (S187). In S184, when it is determined that there is no corresponding item (No in S184), the control unit 400 executes the error processing (S187). Then, the control unit 400 ends the processing.

When it is determined that the merchandise code is not included in register-minus data (No in S181), the control unit 400 determines whether or not a merchandise name and a unit price of an item are included in register-minus data (S191). When it is determined that the merchandise name and the unit price of the merchandise are included (Yes in S191), the control unit 400 determines whether or not a membership code is included in register-minus data (S192).

When it is determined that the membership code is included (Yes in S192), the control unit 400 searches the presence or absence of the item of the corresponding merchandise code with respect to the entire electronic receipt data associated with the included membership code (S193). As a result of the search, it is determined whether or not there is the corresponding item (S194). When it is determined that there is the corresponding item (Yes in S194), the control unit 400 executes the processing of S185 on the item.

In S191, when it is determined that the merchandise name and the unit price are not included (No in S191), the control unit 400 executes the error processing (S195). In S192, when it is determined that the membership code is not included in the stored register-minus data (No in S192), the control unit 400 executes the error processing (S195). In S194, when it is determined that there is no corresponding item (No in S194), the control unit 400 executes the error processing (S195). Then, the control unit 400 ends the processing.

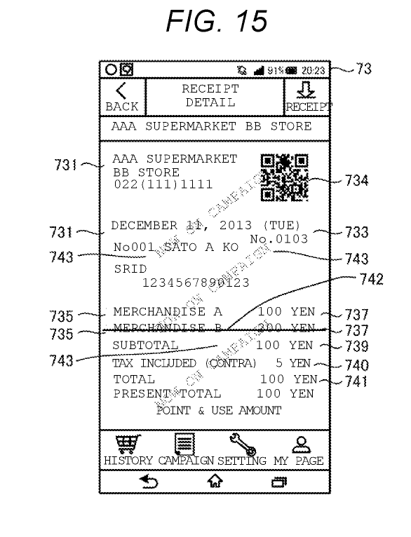

Next, an electronic receipt which is output from the electronic receipt management server 4 to the mobile terminal 7 and is browsable by a customer will be described with referring to FIGS. 14 and 15. FIG. 14 illustrates an example of an electronic receipt which is displayed on the display unit 73 of the mobile terminal 7, which receives the electronic receipt generated in S85 and output in S86 when it is determined to be No in S83.

In FIG. 14, the display unit 73 displays, as an electronic receipt, a store name logo 731, date and time 732 on which the transaction has been carried out, a transaction number 733, a two-dimensional code 734 obtained by symbolizing the transaction number, transaction information, or the like, a merchandise name 735 of each purchased item, a price 737 of each item, a subtotal 739, a tax 740, a total price 741, and the like. A customer who carries the mobile terminal 7 may browse the electronic receipt displayed on the display unit 73 of the mobile terminal 7 and may confirm the content of the purchase transaction.

The display unit 73 displays, as background information which is additional information, the watermark characters 743 of “now on campaign”. The background information including the watermark characters 743 is displayed on the display unit 73, but is not printed on a normal receipt which is printed and issued by the POS terminal 1. The watermark characters 743 do not interfere with the display of the electronic receipt displayed on the display unit 73. For example, when the display on the display unit 73 is copied to generate a paper receipt, in the copied paper receipt, the watermark characters 743 of “now on campaign” can be recognized clearly.

For this reason, the customer who views the mobile terminal 7 can recognize that a promotional campaign is being carried out in the store, which may result in increased sales at the store. When the display of the display unit 73 is copied, the presence of the watermark characters 743 allows the sales clerk to understand that the sheet is not issued by the POS terminal 1 and is a copy of the electronic receipt. That is, it is possible for the sales clerk to identify a sheet which is improperly generated by copying the display of the display unit 73. Since the watermark characters 743 of “now on campaign” displayed as the background information on the display unit 73 may be recognized by the user, the user would be discouraged from copying the display.

As described above, the watermark characters 743 may be arbitrarily set. For example, characters “electronic receipt” indicating that the display is an electronic receipt, characters “no copy” to discourage copying of the display, or the like may be used as watermark characters, in addition to characters intended for sales promotion, such as “now on campaign”.

FIG. 15 illustrates an example of an electronic receipt which is displayed on the display unit 73 of the mobile terminal 7, which receives an electronic receipt generated in S85 and output in S86 when it is determined to be Yes in S83. That is, the example of FIG. 15 is a display example of an electronic receipt when the merchandise return processing or the register-minus processing is executed. In FIG. 15, in addition to the display items described with referring to FIG. 14, a struck-through line 742 is displayed as additional information on merchandise information of a returned item. In FIG. 15, the struck-through line 742 is displayed on merchandise information of a merchandise B. A customer who views the display may visually recognize that the merchandise B is subjected to the merchandise return processing. As a mark indicating that an item is returned, the color of merchandise information of a returned item may be changed or shaded, or a mark indicating the return of the item may be displayed, instead of a struck-through line 742.

In accordance with execution of the merchandise return processing, each of the subtotal, the tax, and the total price of the electronic receipt generated in S85 is changed to the amount changed in S78. In the embodiment, the subtotal 739 is changed from 300 yen to 100 yen. The tax 740 is changed from 15 yen to 5 yen. The total price 741 is changed from 300 yen to 100 yen.

In the embodiment, the electronic receipt management server 4 outputs an electronic receipt including additional information to a reception destination device. The customer can view the electronic receipt displayed on the mobile terminal 7 which receives the electronic receipt and recognize that the sale promotion is offered in the store.

In the embodiment, as the watermark characters are appended as the background information, it is possible to use the watermark characters for sales promotion and to recognize a counterfeit copy of an electronic receipt displayed on the mobile terminal 7. This results in suppressing the creation of counterfeit receipts.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form according to the embodiments described herein may be made without departing from the spirit of the inventions. The accompanying claims and their equivalents are intended to cover such forms or modifications as would fall within the scope and spirit of the inventions.

For example, in the above-described embodiment, although the membership code and the like are input using the code reading unit 15, the disclosure is not limited thereto, and the membership code and the like may be input using other methods. Specifically, the membership code and the like may be transmitted and received using a short-range radio communication, such as a near field communication (NFC) or Bluetooth (Registered Trademark). In this case, it is assumed that the mobile terminal 7 stores the membership code and the like in the storage unit 75, an IC tag (not illustrated), or the like.

In the above-described embodiment, although the POS terminal 1 receives the membership code and the like from the mobile terminal 7 as an input, the membership code and the like may be input from a medium (membership card), such as an IC card or a magnetic card, which may stores a membership code. When an IC card is used, the POS terminal 1 includes a reading and writing unit, such as an IC card reader and writer. When a magnetic card is used, the POS terminal 1 includes a card reader and a card writer of the magnetic card, or the like.

In the above-described embodiment, electronic receipt data, merchandise return data, and register-minus data are transmitted directly from the POS terminal 1 to the electronic receipt management server 4. As another example, a company electronic receipt server which collects and manages electronic receipt data in a company may be provided in the headquarter P2. Further, the electronic receipt data may be transmitted from the POS terminal 1 to the electronic receipt management server 4 through the electronic receipt server.

In the above-described embodiment, although the mobile terminal 7 receives the electronic receipt from the electronic receipt management server 4, the mobile terminal 7 may receive the electronic receipt through the POS terminal 1. In this case, the POS terminal 1 outputs the electronic receipt to the mobile terminal 7 connected through the network N1 in the store P1 or a short-range radio communication unit.

In the above-described embodiment, although a merchandise data file is stored in the POS terminal 1, the disclosure is not limited thereto, and the store server 2 may store a merchandise data file which may be referred to from the POS terminal 1.

In the above-described embodiment, the electronic receipt management server 4 generates an electronic receipt including additional information based on the stored electronic receipt data. However, the POS terminal 1 may generate an electronic receipt including additional information.

The calculation of new total price information accompanied with the merchandise return processing or the register-minus processing or processing of new total price information to be recognizable is not an essential requirement.

The program which is executed by the electronic receipt management server 4 according to the embodiment maybe provided in the form of being recorded in a computer-readable recording medium, such as a CD-ROM, a flexible disk (FD), a CD-R, or digital versatile disk (DVD), as a file in an installable format or an executable format.

The program which is executed by the electronic receipt management server 4 according to the embodiment may be stored on a computer connected to a network, such as the Internet, and may be downloaded through a network. Furthermore, the program which is executed by the electronic receipt management server 4 according to the embodiment may be provided or distributed through a network, such as the Internet.

The program which is executed by the electronic receipt management server 4 according to the embodiment may be provided in the form of being incorporated in a ROM or the like in advance.

1. (canceled)

2. An information processing system, comprising:
a display device;
a processor configured to generate an electronic receipt inquiry; and
a communication interface through which the electronic receipt inquiry is transmitted over a network and through which electronic receipt data and background image data are received in response to the electronic receipt inquiry, wherein the processor is further configured to control the display device to display an electronic receipt image generated from the electronic receipt data with a background image generated from the background image data.

3. The information processing system according to claim 2, wherein
the background image includes at least one of a pattern, a photograph and watermark characters.

4. The information processing system according to claim 2, wherein
the background image includes watermark characters.

5. The information processing system according to claim 4, wherein
the watermark characters do not interfere with a display of the electronic receipt image.

6. The information processing system according to claim 4, wherein
the watermark characters indicate a promotional campaign.

7. The information processing system according to claim 4, wherein
the watermark characters provide a security feature against counterfeiting.

8. The information processing system according to claim 2, wherein the electronic receipt inquiry includes a user code and a date and the electronic receipt data contains information about purchases made with the user code on said date.
